(19) United States
(12) Patent Application Publication
(10) Pub. No.: US 2024/0190327 A1
(43) Pub. Date: Jun. 13, 2024

(54) LOGISTICS SYSTEM

(71) Applicant: Ford Global Technologies, LLC, Dearborn, MI (US)

(72) Inventors: Bas van den Heuvel, Wijnandsrade (NL); Rob Stalman, Selfkant (DE); Mark Gijbels, Vlaams-brabant (BE); Rainer Souschek, Aachen (DE); Martin Kapp, Dormagen (DE); Pieter Diepenmaat, Rotterdam (NE); Wouter van der Hoog, Dearborn, MI (US)

(73) Assignee: Ford Global Technologies, LLC, Dearborn, MI (US)

(21) Appl. No.: 18/536,161

(22) Filed: Dec. 11, 2023

(30) Foreign Application Priority Data
Dec. 12, 2022 (DE) 102022132923.2

(51) Int. Cl. B60P 1/64

(52) U.S. Cl. CPC B60P 1/6427; B60P 1/6454; B60P 1/649

(57) ABSTRACT

The invention relates to a logistics system having a large vehicle, a small vehicle and a container. According to the invention, in order to allow containers to be used on different vehicles in an improved manner, the container can be received, with a long side oriented along a transverse direction of the large vehicle, on said large vehicle and, interacting with same via a first movement arrangement, can be moved along a longitudinal direction of the large vehicle, said container can furthermore be received, with the long side oriented along a longitudinal direction of the small vehicle, on said small vehicle and, interacting with same via a second movement arrangement, can be moved along the longitudinal direction of the small vehicle, and said container has multiple legs which, in order for the container to be received on a vehicle, are adjustable from a deployed position into a retracted position.

### CROSS-REFERENCE TO RELATED APPLICATIONS

The applications claims priority to and the benefit of German Application No. 102022132923.2, filed Dec. 12, 2022, which is hereby incorporated by reference herein in its entirety.

### FIELD OF THE INVENTION

The invention relates to a logistics system.

### BACKGROUND

In the logistics sector, the efficiency of cargo exchange throughout the entire delivery chain is a crucial factor. Here, vehicle-to-vehicle (V2V) cargo exchange, where a transfer takes place directly from one vehicle to another, is advantageous in many respects but also poses challenges. For example, the transport of individual goods or of a collection of goods in or on goods carriers (for example carriages, racks or pallets) still requires considerable handling effort. Furthermore, the goods can be exposed to environmental or weather influences. In this respect, it is advantageous to use containers that accommodate the goods. However, these relatively large and heavy containers can generally be transferred only using special machines (for example a crane). Manual transfer concepts have also been developed, but these are often work-intensive, inefficient and problematic in terms of safety, and are therefore suitable only for relatively small containers, which are transferred for example onto cargo bicycles or subcompact cars.

No efficient concept exists for transferring relatively large containers which can for example occupy the entire cargo area of a small urban delivery vehicle, often referred to as a “light electric freight vehicle” (LEFV). Such LEFVs can advantageously be used for the so-called “last mile”, that is to say for the route to the end customer. A further problem consists in that the dimensions of a container may not fit well with the dimensions of the different vehicle types. For example, the vehicle that hands over a container to a delivery vehicle (such as an LEFV) for the last mile may have a significantly different width. Furthermore, the vehicle may normally receive several such containers in order to operate economically. The vehicle for the last mile may have to be of smaller width, for example in order to be able to deliver items efficiently in urban areas. Transferring the containers onto vehicles with such different dimensions is difficult and relatively inefficient.

WO 2006/111 620 A1 discloses a container having wheels that are pivotable through 90°, whereby said container can either be moved laterally under a crossmember of a transport vehicle or pulled onto a rear-end ramp of a truck. The pivoting of the wheels may be implemented hydraulically, and initiated by remote control.

EP 4 033 429 A1 presents a method for delivering parcels, in which method the parcels are received in containers and are then loaded onto transport vehicles. The individual container has multiple wheels, by means of which said container can be moved on the ground, and multiple rollers, which do not make contact with the ground. When the container is moved onto an inclined loading edge of a transport vehicle, the rollers make contact with the loading edge and the container is raised slightly, whereby the wheels can be pivoted in. On the transport vehicle, the container can be moved by means of the rollers.

US 2021/0 253 348 A1 has disclosed a storage system comprising a storage grid structure having a top rail grid upon which container handling vehicles work to store and retrieve storage containers in and from storage columns beneath the top rail grid. The storage system comprises multiple transfer rails forming a horizontal transfer rail grid arranged at a level below the top rail grid, at least one transport vehicle operating on the transfer rail grid. The transport vehicle is arranged to move upon the transfer rail grid in two perpendicular directions. For this purpose, the transport vehicle has first wheels and second wheels arranged transversely to the first wheels. The first or second wheels can be selectively raised and thus decoupled from the transfer rails.

WO 2021/91 926 A1 discloses a frame arrangement, the primary rolling means of which are fastened to vertically extendable legs which can be retracted vertically into the frame arrangement, and the secondary rolling means of which are fastened to ends of a horizontally extendable frame that is installed movably in the base of the frame arrangement. By extending the legs, the frame can be brought to the level of a cargo floor of a transport vehicle. The frame arrangement can be supported on the cargo floor by means of the frame, such that the legs can be successively retracted as the frame arrangement is moved horizontally onto the cargo floor.

US 2021/0 206 566 A1 presents a cargo container for maritime transport of cargo, having engagement portions for a container crane, and having wheels that are configured to support the cargo container. Each wheel is adjustable between a running state, in which it supports the container, and a loaded state, in which the wheel has been retracted into the container.

In view of the prior art highlighted here, the use of containers on different vehicles, and the transfer of cargo between these vehicles, still have potential for improvement.

### SUMMARY

The invention is based on the object of allowing containers to be used on different vehicles in an improved manner.

According to the invention, the object is achieved by means of a logistics system having the features of claim 1, wherein the subclaims relate to advantageous refinements of the invention.

Note that the features and measures individually specified in the following description may be combined with one another in any technically meaningful way and reveal further refinements of the invention. The description additionally characterizes and specifies the invention, in particular in conjunction with the figures.

The invention provides a logistics system. The expression “logistics system” refers to the fact that it is usable in the logistics sector, and is in particular provided for this purpose. It may in particular be provided for transporting goods or consignments to an end customer. The term “system” is not to be interpreted as meaning that it must imperatively have multiple constituents.

The logistics system has a large vehicle, a small vehicle and a container. In particular, the logistics system may have multiple large vehicles, multiple small vehicles and/or multiple containers. The large vehicle and the small vehicle are generally trucks, that is to say road vehicles. The large vehicle is generally a vehicle with a normal track width (for example between 1.80 m and 2.55 m). It is preferably designed to receive multiple containers. The small vehicle may in particular be designed as a light electric freight vehicle (LEFV). Such LEFVs are distinguished by a small size and a low curb weight (typically at most 1 t) and generally by a small track width (for example at most 1.4 m). The small vehicle may be designed to receive exactly one container.

The container may have a container body, which may in particular be cuboidal. The container, in particular the container body, serves to receive goods or consignments. The container has at least one opening for the introduction and removal of consignments. Said opening may be closable by means of a door, which may be designed for example as a pivoting door, sliding door or roller door. It is also possible for multiple openings having corresponding doors to be provided.

The container can be received, with a long side oriented along a transverse direction of the large vehicle, on said large vehicle and, interacting with same via a first movement arrangement, can be moved along a longitudinal direction of the large vehicle. The longitudinal direction of the vehicle runs parallel or antiparallel with respect to the direction of straight-ahead travel. The long side is a side of the container, in a horizontal direction, which is longer than a short side. The length ratio of the long side with respect to the short side may assume different values, for example may be between 1.5:1 and 3:1. Other ratios are however also conceivable. The long side can be identified with a longitudinal direction of the container, and the short side with a transverse direction. Here, a short side may have a short-side opening that is closable by means of a short-side door, whilst a long side has a long-side opening that is closable by means of a long-side door. In particular, two long-side openings and long-side doors may be provided on opposite sides of the container. The container can be received on a large vehicle such that the long side of said container is oriented along the transverse direction of the large vehicle. It can also be said that the container can be received transversely on the large vehicle. So as not to exceed a maximum admissible width of the large vehicle including the container (for example at most 2.55 m), the length of the container along the long side may be limited to this width extent. Normally, the large vehicle is configured to receive multiple containers one behind the other in a longitudinal direction. This is promoted by virtue of the short side of each container being oriented along the longitudinal direction of the large vehicle.

The large vehicle normally has a cargo bed that is designed to receive at least one container. Here, the width of the cargo bed may correspond to, or be less than, the length of the container along its entire long side. That is to say, the container may optionally project beyond the cargo bed in a transverse direction. The container can be moved along the longitudinal direction of the large vehicle by interacting with the large vehicle via a first movement arrangement. Here and below, the expression “movable along a longitudinal direction” means that there is mobility with at least a component, in particular a predominant component, parallel to the longitudinal direction. The mobility may also have a component in a vertical direction and/or in a transverse direction. In relation to the container, this is a movement transversely to the long side, that is to say in the direction of the short side. The first movement arrangement allows the mobility of the container and may in particular promote same, for example by ensuring a low friction force during the corresponding movement. For example, the first movement arrangement may have at least one rotatably mounted roller element, in particular multiple roller elements. The first movement arrangement is normally assigned both partially to the large vehicle and partially to the container, that is to say has both at least one constituent on the large vehicle and at least one constituent on the container, which constituents interact with one another. In particular, by means of the first movement arrangement, the container may be capable of being pushed onto the large vehicle, or onto the cargo bed thereof, from a rear end of the large vehicle.

Furthermore, the container can be received, with the long side oriented along a longitudinal direction of a small vehicle, on said small vehicle and, interacting with same via a second movement arrangement, can be moved along the longitudinal direction of the small vehicle. The container can be received on a small vehicle such that the long side of said container is oriented (that is to say aligned) along a longitudinal direction of the small vehicle. It can also be said that the container can be received longitudinally on the small vehicle. The small vehicle also normally has a cargo bed that is designed to receive at least one container, normally to receive exactly one container. The container may optionally project beyond the cargo bed in a longitudinal direction and/or in a transverse direction. So as not to exceed a maximum admissible or desired width of the small vehicle including the container (for example at most 1.4 m), the width of the container along the short side may be correspondingly limited. The container can be moved along the longitudinal direction of the small vehicle by interacting with the small vehicle via a second movement arrangement. In relation to the container, this is a movement in the direction of the long side. The second movement arrangement allows the mobility of the container and may in particular promote same, for example by ensuring a low friction force during the corresponding movement. The second movement arrangement, too, may have at least one rotatably mounted roller element or multiple roller elements. The second movement arrangement is normally assigned both partially to the small vehicle and partially to the container, that is to say has both at least one constituent on the small vehicle and at least one constituent on the container, which constituents interact with one another. In particular, by means of the first movement arrangement, the container may be capable of being pushed onto the small vehicle, or onto the cargo bed thereof, from a rear end of the small vehicle.

The container furthermore has multiple legs which, in order for the container to be received on a vehicle, are adjustable from a deployed position into a retracted position. The legs are arranged adjustably on the abovementioned container body. In a deployed position, said legs project downward from the container body. In this deployed position, said legs serve to support the container body on the ground. Normally, at least four legs, in particular exactly four legs, are provided. The legs are adjustable into a retracted position; this encompasses both manual adjustability and adjustability by motor or actuator means. Normally, the legs are permanently connected to the container body, such that an adjustment is possible without detaching the legs. The adjustment into the retracted position is intended for a situation in which the container is to be received on a vehicle, that is to say the large vehicle or the small vehicle. In the retracted position, the legs have, overall, been adjusted upward relative to the deployed position, and project downward to a lesser extent, or even do not project downward at all, from the container body. The adjustment may in particular be translational and/or rotational. It is also conceivable for parts of a leg to be adjusted relative to one another, for example with telescopic or buckling, that is to say foldable, action.

The logistics system allows an efficient transfer of the container between the large vehicle and the small vehicle, as well as efficient transport of the container. By means of the first movement arrangement, the container can be moved easily, possibly even manually, on the large vehicle. This allows suitable positioning on the large vehicle. The container can also be easily loaded and unloaded via the rear end whilst being supported entirely or partially via the movement arrangement. When its legs are in the deployed position, the container can be set down on the ground. The container body is thus at an advantageous height that promotes loading. For reception on one of the vehicles, the legs may be adjusted into their retracted position so as not to cause an obstruction that would impede reception and/or movement on the vehicle. Correspondingly, by means of the second movement arrangement, the container can be moved easily, possibly even manually, on the small vehicle. This allows suitable positioning, as well as possible loading and unloading via the rear end. The two movement arrangements support a different arrangement on the two vehicles. The container can thus be positioned transversely on the large vehicle, whereby a greater (admissible) width of the large vehicle can be optimally utilized. Furthermore, multiple containers can thus advantageously be received one behind the other along a longitudinal direction of the large vehicle. On the small vehicle, the container is received longitudinally, such that its short side is oriented along a transverse direction of the small vehicle and thus the overall width of the small vehicle (including the container) can be kept small.

Preferably, at least one movement arrangement has at least one vehicle-mounted track element and, interacting therewith, at least one container-mounted runner element. The track element extends in a longitudinal direction, but does not necessarily run parallel to the longitudinal direction. By its direction of extent, said track element normally defines the direction of the mobility of the container. Said track element may optionally have guide structures which, transversely to the direction of extent, produce a form fit with the runner element. The track element is normally arranged on, or forms a part of, the cargo bed. Said track element may have both elements that are connected fixedly to a vehicle body of the vehicle and elements that are movable relative to the vehicle body, in particular the aforementioned roller elements. The vehicle may have multiple track elements. The container has at least one runner element which interacts with, and is movable along, the at least one track element. The runner element may be fixedly connected to, and may even form a part of, the container body. Said runner element may however also be movably, in particular rotatably, connected to the container body. Said runner element may have at least one roller element that can roll on a track element. The vehicle may have multiple runner elements. In particular, multiple runner elements may be provided for interacting with a single track element.

In one refinement, provision is made for the first movement arrangement to have first roller elements, which are arranged on the container and oriented transversely to the long side of same, as runner elements, and to have first rails, which are arranged on the large vehicle and extend along the longitudinal direction of same, as track elements. The first roller elements are rotatable relative to the container body. Their axis of rotation is normally in a fixed position on the container body. Said first roller elements are oriented transversely to the long side, i.e., can roll transversely to the long side, that is to say parallel to the short side. Their respective axes of rotation are in this case oriented parallel to the long side. The first rails form track elements with which the first roller elements interact. Said rails may, at least in part, be fixedly connected to the vehicle body. Provision is normally made here for the first roller elements to be guided along the first rails, that is to say for a form fit with the first roller elements to be produced transversely to the direction of extent of the first rails. At least in some embodiments, the first roller elements may also be referred to as first wheels. It is preferable for two first rails and four first roller elements to be provided.

Provision may furthermore be made for the second movement arrangement to have second roller elements, which are arranged on the container and oriented parallel to the long side of same, as runner elements, and to have second rails, which are arranged on the small vehicle and extend along the longitudinal direction of same, as track elements. The second roller elements are rotatable relative to the container body. Their axis of rotation is normally in a fixed position on the container body. Said second roller elements are oriented parallel to the long side, i.e., can roll parallel to the long side, that is to say transversely to the short side. Their respective axes of rotation are in this case oriented transversely to the long side. The second rails form track elements with which the second roller elements interact. Said rails may, at least in part, be fixedly connected to the vehicle body. Here, too, provision is normally made here for the second roller elements to be guided along the second rails, that is to say for a form fit with the second roller elements to be produced transversely to the direction of extent of the second rails. At least in some embodiments, the second roller elements may also be referred to as second wheels. It is preferable for two second rails and four second roller elements to be provided.

In order to prevent the first roller elements from colliding with the second rails or the second roller elements from colliding with the first rails, provision is preferably made for the first roller elements and the second roller elements to project downward from a container body to different extents. This may mean that the first and second roller elements are of different size and/or that their axes of rotation are arranged different distances below the container body. Alternatively or in addition, a collision can also be avoided if the first roller elements are arranged offset with respect to the second roller elements both parallel to the long side and parallel to the short side.

To guide roller elements of the container to both sides in the transverse direction, the rails of at least one vehicle may have flange portions. The flange portions normally extend in a vertical direction. They may project upward laterally with respect to at least one base portion of the rail. They produce a form fit with the roller elements of the container in a transverse direction, specifically to both sides, that is to say to the “left” and to the “right”. Here, a form fit may be produced with different roller elements in one direction than in the other direction. For example, a “left-hand” rail could produce a form fit to the “left” with “left-hand” roller elements, whilst a “right-hand” rail produces a form fit to the “right” with “right-hand” roller elements. The rails preferably have a run-in region in which the flange portions are inclined toward the transverse direction in relation to the longitudinal direction and in which the spacing of said flange portions decreases in a forward direction as viewed from the rear end of the vehicle. The run-in region makes it easier for the roller elements to be introduced into the rails.

As already mentioned above, each container may have at least one long-side opening, in particular two long-side openings on opposite sides. Aside from the loading and unloading of consignments into and out of the container, this can also be utilized to allow a direct transfer of cargo from one container to the other. In one preferred refinement, multiple containers can be received on the large vehicles such that long sides of in each case two containers are arranged adjacent to one another, and consignments can be transferred between the containers via long-side openings formed in the long sides. That is to say, the long sides of the containers, which are oriented along the transverse direction of the large vehicle, face one another and are adjacent to one another. Here, a certain spacing may remain between the long sides of the containers, which spacing is however typically at most a few centimeters or even a few millimeters. The containers may also be in contact with one another. With suitable arrangement, the long-side openings of two containers that are arranged adjacent to one another in a longitudinal direction of a large vehicle may overlap, such that consignments can be transferred directly from one container to the next through the long-side openings. This is self-evidently the case when long-side doors are open. It is furthermore possible for consignments to be transferred from the rearmost container in a direction of travel into the next container toward the front, and onward from there into the next but one. It is thus possible for all of the containers to be loaded successively via the rearmost container without having to be unloaded from the large vehicle. Unloading is also possible via the rearmost container. Container floors of the containers are in this case advantageously arranged at least adjacent to one another. A virtually step-free and gapless transition from one container floor to the next is thus possible. This in turn is advantageous if the consignments consist of trolleys or have been loaded onto trolleys. The individual trolleys can then be pushed from one container floor onto the next, making a transfer much easier. The height of the container floor and the height of the cargo bed of the large vehicle may be coordinated with the height of a static platform such that the trolleys can be transferred, without a (significant) difference in height, from the platform into the rearmost container and vice versa.

In order to make the loading and unloading of the container easier, provision is advantageously made for at least one vehicle to have a ramp unit which is at least downwardly tiltable and which is configured to support at least one runner element whilst at least one leg is in contact with the ground. The ramp unit is arranged to the rear, that is to say at the rear end, with respect to the longitudinal direction of the vehicle. Said ramp unit is either downwardly tiltable or is permanently downwardly tilted. This refers to a downward tilt from front to rear, that is to say the rear part of the ramp unit is arranged (or can be arranged) lower than the front part. The ramp unit may have at least one track element or a portion of a track element, in particular a rail or a portion of a rail. The ramp unit is configured to support at least one runner element whilst at least one leg of the container is standing on the ground. In this state, the container is thus supported partially on the vehicle, via the at least one runner element and the ramp unit, and partially on the ground, via the at least one leg. For this purpose, the tilt and height of the ramp unit are adapted to the dimensions of the container and in particular of the at least one leg. Here, the corresponding leg is in its deployed position. Owing to the support provided partially via the ramp unit, on the one hand, and partially via the legs, on the other hand, the loading and unloading of the container are made easier. For example, during the loading process, the ramp unit can relieve adjacently arranged legs of load, such that said legs can be adjusted into the retracted position. During unloading, it is correspondingly possible for legs to be gradually adjusted into their deployed position whilst the container is still supported via the ramp unit. Owing to the tilt of the ramp unit, container can, during unloading, be gradually lowered whilst being pushed towards the rear end. Conversely, in accordance with the principle of an oblique plane, said container can be gradually raised whilst being pushed forward from the rear end during the loading process. Here, firstly the front legs, and then the rear legs, can be relieved of load and then adjusted into the retracted position.

Preferably, in order to receive the container, at least one ramp unit is or can be arranged between two legs of the container in a transverse direction. That is to say, the width of the ramp unit in a transverse direction of the relevant vehicle is smaller than the spacing of the legs. Accordingly, the vehicle can be moved to bring the ramp unit between the legs, for example by virtue of the vehicle being reversed. Conversely, the container could be moved forward to the vehicle until the ramp unit is arranged between the legs. Likewise, during unloading, the legs can be adjusted into the deployed position to the sides of the ramp unit whilst the container body is still arranged entirely or partially on the ramp unit.

One refinement provides for at least one ramp unit to be pivotable about a pivot axis running in a transverse direction. By way of a corresponding pivoting operation, the ramp unit can be either downwardly tilted or for example set into a horizontal position, upwardly tilted or even set into a vertical position. By means of a horizontal or upwardly tilted position, the ramp unit can for example be used to receive a container from, or transfer a container onto, an elevated platform. By means of a steeply upwardly tilted or vertical position, the ramp unit can be utilized to form a rear boundary of the cargo bed, whereby the one or more containers can be secured against falling off. A different tilt of the ramp unit can possibly also be utilized to be able to better receive or set down the container if the underlying surface is not horizontal and there are therefore height differences between the position of the vehicle and the position of the container.

Preferably, at least one vehicle has a traction device which is couplable to the container and which is configured to pull the vehicle and the container toward one another along the longitudinal direction. The traction device may in particular have a winch and a traction cable that is provided with a suitable coupling element in order to be coupled to the container. This could for example be a hook that is hooked into an eyelet on the container. Depending on the state of the container and that of the vehicle, the vehicle may remain stationary whilst the container moves toward the vehicle, the container may remain stationary whilst the vehicle moves toward the container, or both may move. The traction device may furthermore be configured to pull the container on the vehicle into an intended position relative to the longitudinal direction.

At least one vehicle may have a conveyor device which is configured to form-fittingly engage with the container and push the container, which is received on the vehicle, along the longitudinal direction. The conveyor device may have one or more driver elements that can engage with a particular region on the container, for example on the container body, and drive the container along. For example, the conveyor device may have a circulating conveyor element, a type of conveyor belt or link conveyor, which bears the driver elements. The conveyor device may be arranged between two track elements in a transverse direction, along which track elements the runner elements of the container are moved. By means of multiple driver elements, it would also be possible for multiple containers to be moved simultaneously.

### BRIEF DESCRIPTION OF THE DRAWINGS

Further advantageous details and effects of the invention will be discussed in more detail below on the basis of various exemplary embodiments illustrated in the figures, in which:

FIG. 1 shows a perspective view of elements of a logistics system according to the invention;

FIG. 2 shows a side view of a first embodiment of a large vehicle laden with containers of the logistics system from FIG. 1;

FIG. 3 shows a rear view of the large vehicle from FIG. 2;

FIGS. 4-6 show side views of the large vehicle from FIG. 2 during the unloading of a container;

FIGS. 7-8 show side views of a second embodiment of a large vehicle during the loading of a container;

FIG. 9 shows a side view of a third embodiment of a large vehicle having three containers, during the loading of consignments into the container;

FIG. 10 shows a side view of a first embodiment of a small vehicle laden with a container of the logistics system from FIG. 1;

FIG. 11 shows a rear view of the small vehicle from FIG. 10;

FIG. 12 shows a sectional illustration, from the rear, of a detail of the small vehicle and of the container from FIG. 10;

FIG. 13 shows a plan view of a detail of the small vehicle from FIG. 10;

FIGS. 14-15 show side views of the small vehicle from FIG. 10 during the unloading of a container;

FIG. 16 shows a side view of a second embodiment of a small vehicle and of a container of the logistics system from FIG. 1;

FIGS. 17-19 show side views of a third embodiment of a small vehicle laden and of a container of the logistics system from FIG. 1;

FIG. 20 shows a perspective view of a first embodiment of a container of the logistics system from FIG. 1; and

FIG. 21 shows a perspective view of a second embodiment of a container of the logistics system from FIG. 1.

### DETAILED DESCRIPTION

In the various figures, identical parts are usually denoted by the same reference designations, for which reason said parts will generally also be described only once.

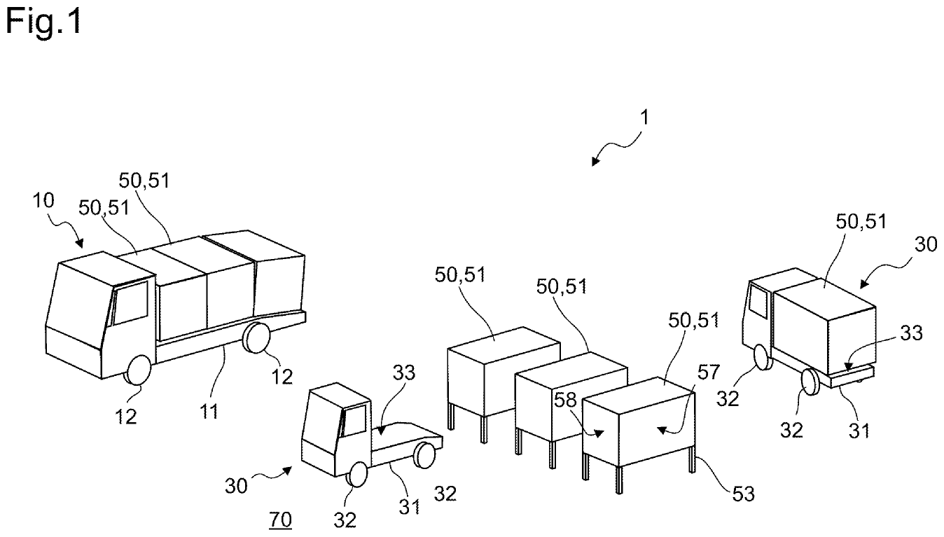

FIG. 1 shows various constituents of a logistics system 1 according to the invention in a perspective illustration. A large vehicle can be seen, which in this case is designed as a mid-size truck 10. The truck 10 has a vehicle body 11 and wheels 12 arranged thereon. Formed in a rear region of the vehicle body 11 is a cargo bed 13 which, in FIG. 1, receives three containers 50. Also shown are two small vehicles designed as LEFVs 30 (LEFV=light electric freight vehicle). Each LEFV 30 has a vehicle body 31 having wheels 32 arranged thereon and has a cargo bed 33 formed on the vehicle body 31. In the case of one of the LEFVs 30, a single container 50 is received on the cargo bed 33, whilst the other LEFV 30 is presently unladen. Also illustrated are three containers 50 which are presently not received on any of the vehicles 10, 30 but have been set down on the ground 70 by way of legs 53. The legs 53 are arranged on a container body 51 which is cuboidal and which has a long side 57 and a short side 58.

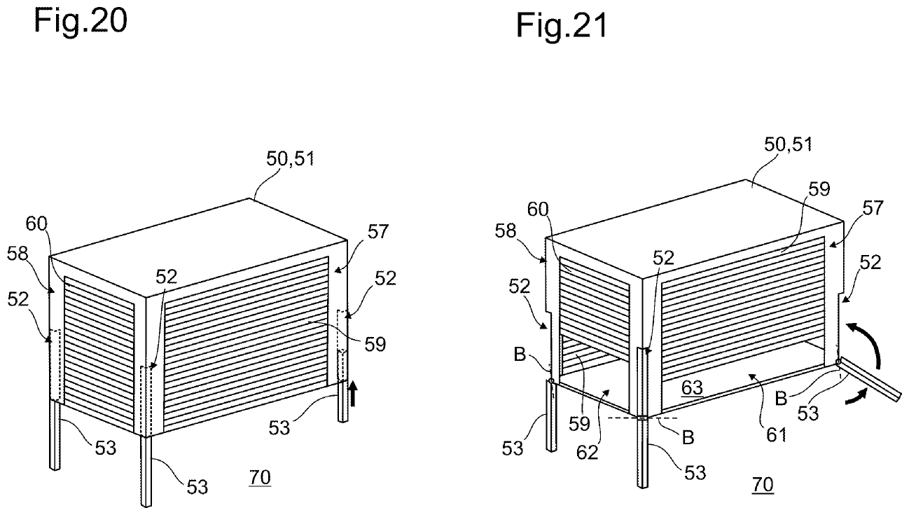

FIGS. 20 and 21 each illustrate, by way of example, a container 50 on its own. A short side 58 has a short-side opening 62 that can be closed by means of a short-side door 60, which is configured here in the manner of a roller door. The long sides 57 each have long-side openings 61 that can be closed by long-side doors 59, which are likewise configured as roller doors. The container 50 has a container floor 63, which in this case is flat.

FIG. 20 shows a first embodiment of a container 50, in which the legs 53 are adjustable between the deployed position and the retracted position by translational adjustment in a vertical direction. This may be performed by means of actuators (not illustrated) or manually. In the retracted position, the legs 53 are received in recesses 52 within the container body 51. FIG. 21 shows a second embodiment of a container 50, in which the legs 53 are adjustable between the deployed position and the retracted position by pivoting about second pivot axes B. Here, the second pivot axes B run at an angle of 45° with respect to each of the long side 57 and the short side 58, but could also run parallel to either one of the sides 57, 58. In this case, too, in the retracted position, the legs 53 are received in recesses 52 within the container body 51.

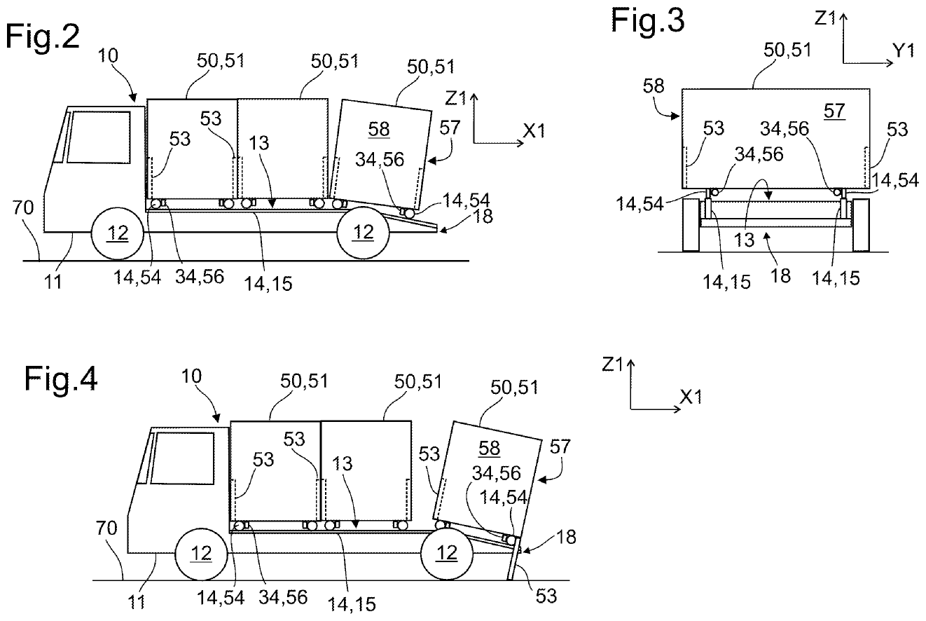

FIGS. 2 to 6 illustrate a first embodiment of a truck 10 in detail. The truck 10 has three containers 50 received thereon, wherein, in each case, a long side 57 is oriented in a transverse direction Y1 of the truck 10 and a short side 58 is oriented along a longitudinal direction X1. Arranged on the cargo bed 13 are first rails 15 that form first track elements of a first movement arrangement 14. Said first rails extend rearwardly along the longitudinal direction X1 of the truck 10 as far as a ramp unit 18, which is slightly downwardly tilted with respect to a vertical direction Z1 of the truck 10. In this example, the rearmost of the containers 50 is standing predominantly on the ramp unit 18, and is therefore slightly tilted. Said container, and the other two containers 50, are secured against rolling away, in a manner that is not illustrated in any more detail. The container body 51 does not stand directly on the cargo bed 13. Rather, said container body has a total of four first roller elements 54, which form runner elements of the first movement arrangement 14 and which are configured to run along the first rails 15. Said container body furthermore has four second roller elements 56, the function of which will be discussed in more detail below. As can be seen in particular in the rear view in FIG. 3, the second roller elements 56 remain free from contact with the first rail 15 and with the cargo bed 13. Said second roller elements therefore do not impede a movement of the container 50 in the longitudinal direction X1 of the truck 10. As the containers 50 are loaded onto the cargo bed 30, the legs 53 are adjusted into a retracted position in which they have been pulled into the container body 51.

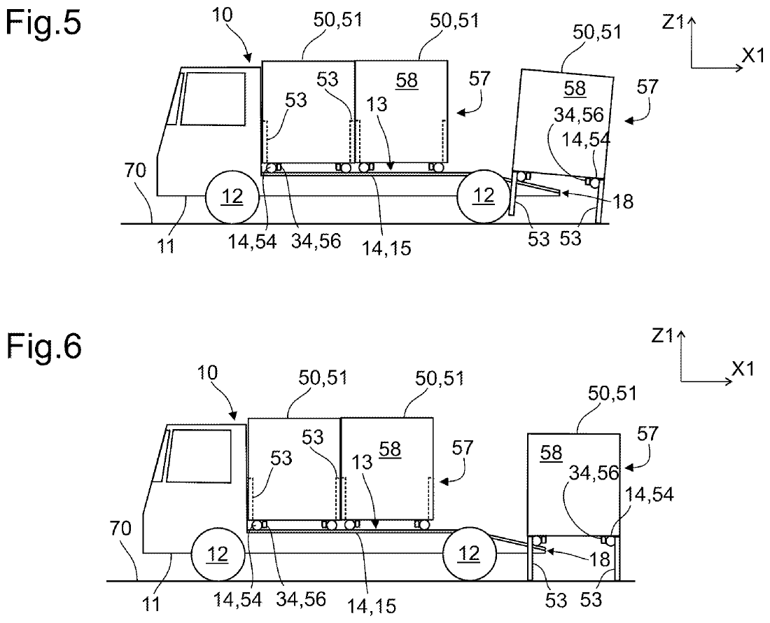

FIGS. 4 to 6 show the unloading of a container 50 from the truck 10. The rear legs 53 are extended into a deployed position, which is possible without problems because the spacing of the legs 53 is greater than the width of the ramp unit 18. The container 50 is then moved down the ramp unit 18 until the rear legs 53 make contact with the ground 70. In this state, the rear first roller elements 54 are still supported by the ramp unit 18. The truck 10 is then driven slowly forward, wherein the container 50, owing to its contact with the ground, is held back and moves further down the ramp unit 18. Owing to the changing inclination of the container 50, the rear first roller elements 54 lose contact with the ramp unit 18, but this is not a problem owing to the support provided by the rear legs 53. As soon as the front legs 53 are arranged behind the rear wheels 12, said front legs can be adjusted into the deployed position as illustrated in FIG. 5. If the truck drives further forward, the container 50 moves further down the ramp unit 18 until the front legs 53 likewise make contact with the ground 70, as illustrated in FIG. 6. Here, the ramp unit 18 is initially still situated between the front legs 53 and supports the front first roller elements 54. The container 50 is thus secured by the ramp unit 18 until all of the legs 53 have been safely set down on the ground 70.

The loading of the container 50 takes place similarly to the unloading process, but in the reverse sequence. Here, the truck 10 initially reverses toward the container 50 until, as illustrated in FIG. 6, the ramp unit 18 moves between the front legs 53 and makes contact, from below, with the front first roller elements 54. Since the ramp unit 18 acts as an oblique plane, a force component is generated along the vertical direction Z1, which force component raises the container 50 such that the front legs 53 lose contact with the ground. Said front legs can then be adjusted into their retracted position. Whilst the truck 10 reverses further, the front first roller elements 54 move up the ramp unit 18. Finally, the rear first roller elements 54 also make contact with the ramp unit 18. This occurs in a state that corresponds to FIG. 4. The weight of the container 50 is then fully supported by the vehicle body 11, and only the relatively low force along the plane of the ramp unit 18 then needs to be imparted in order to move the container into its end position as per FIG. 3. This can generally be done manually. The position of the container 50 can then be secured using means that are not illustrated here.

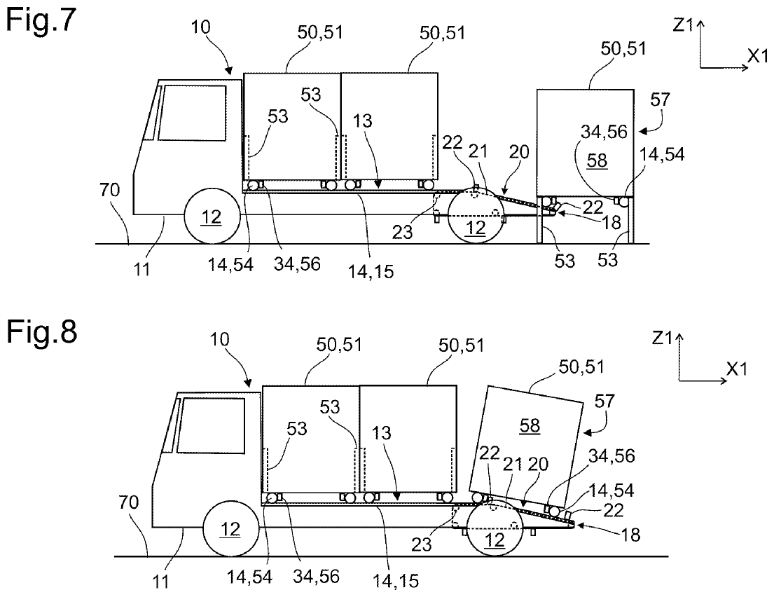

FIGS. 7 and 8 show a second embodiment of a truck 10 according to the invention, which differs from the embodiment illustrated in FIGS. 2 to 6 in that a conveyor device 20 which has a circulating conveyor belt 21 guided over guide rollers 23, and which has driver elements 22 arranged on said conveyor belt, is arranged in the rear region. To load a container 50, the conveyor device 20 is operated counterclockwise as viewed in FIGS. 7 and 8. In a position in which the front roller elements 54 just make contact with the ramp unit 18, one of the circulating driver elements 22 can for example engage with one of the second roller elements 56 or with a common mounting means of the first and second roller elements 54, 56, whereby the container 50 is actively pulled up the ramp unit 18, as illustrated in FIG. 8. The successive adjustment of the legs 53 takes place as described above with regard to the first embodiment.

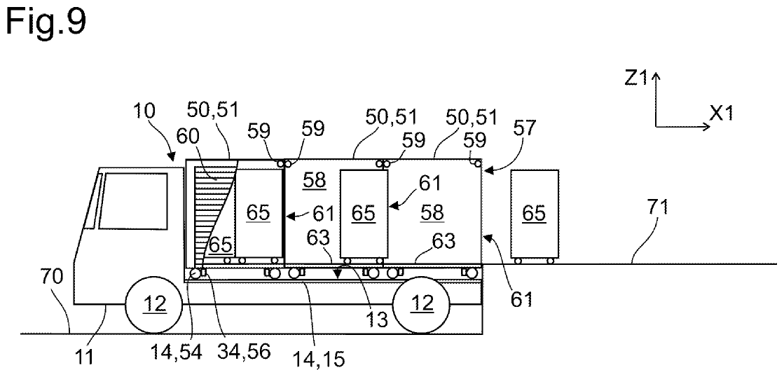

FIG. 9 shows a third embodiment of a truck 10 according to the invention. No ramp unit 18 is illustrated here, but this could be present and could have been retracted or pivoted in in FIG. 9. The truck 10 has three containers 50 received on the cargo bed 13, which containers are shown here partially in section. Said truck is arranged such that the rear end of the cargo bed 13 as viewed in a direction of travel is arranged directly adjacent to a platform 71 from which consignments in the form of trolleys 65 are to be transferred to the containers 50 that are received on the cargo bed 13, without the need for said containers to be unloaded from the truck 10. For this purpose, all of the long-side doors 59 (aside from the frontmost long-side door) are open. Since the long-side openings 61 of adjacent containers 50 thus directly face one another, a transfer of cargo from one container 50 to the next is possible. In particular, the container floors 63 are arranged directly adjacent to one another such that, aside from small intermediate spaces, they form one single continuous floor. This in turn is arranged directly adjacent to, and at the same height as, the platform 71. The trolleys 65 can thus be rolled from the platform 71 through the containers 50 without significant transitions or differences in height, such that the containers 50 can be successively filled. The trolleys 65 can also conversely be unloaded onto the platform by virtue of the trolleys 65 being rolled through the long-side openings 61 from one container 50 to the next and finally onto the platform 71.

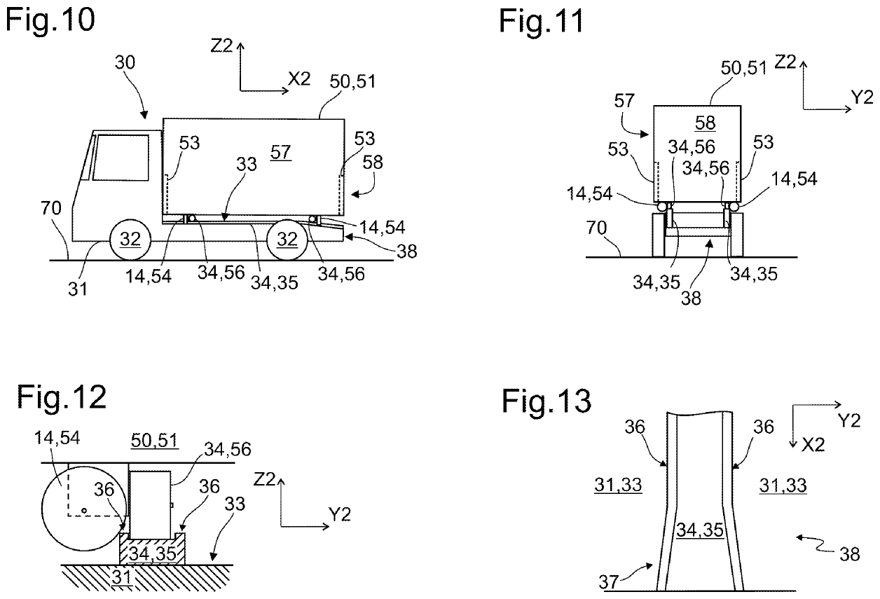

FIGS. 10 to 11 illustrate a first embodiment of a LEFV 30. This has one container 50 received thereon, wherein, in each case, the long side 57 is oriented along a longitudinal direction X2 of the LEFV 30 and a short side 58 is oriented along a transverse direction Y2. Arranged on the cargo bed 33 are second rails 35 that form second track elements of a second movement arrangement 34. Said second rails extend rearwardly along the longitudinal direction X2 as far as a ramp unit 38, which is slightly downwardly tilted with respect to a vertical direction Z2. In this example, the container 50 is standing partially on the ramp unit 38, and is therefore tilted to a minimal degree. Said container is secured against rolling away, in a manner that is not illustrated in any more detail. The container body 51 is supported via the second roller elements 56. These form runner elements of a second movement arrangement 34 and are configured to run along the second rails 35. As can be seen in particular in the rear view in FIG. 11 in the detail view of FIG. 12, the first roller elements 54 remain free from contact with the second rail 35 and with the cargo bed 33. Said first roller elements therefore do not impede a movement of the container 50 in the longitudinal direction X2 of the LEFV 30.

FIGS. 12 and 13 show the structure of the second rails 35 in more detail. Said second rails have two flange portions 36 which produce a form fit with the second roller elements 56 to both sides in the transverse direction Y2. The second roller elements 56, and by means of these the container 50 as a whole, are thus guided. In an end region of the ramp unit 38, the second rails 35 have a run-in region 37 in which the flange portions 36 run obliquely with respect to the longitudinal direction X2, such that the spacing of said flange portions decreases in a forward direction from the rear, before said flange portions thereafter run parallel to one another with a constant spacing. The run-in region 37 makes it easier for the second roller elements 56 to be introduced into the second rails 35. The design of the second rails 35 illustrated here is also transferable to the first rails 15.

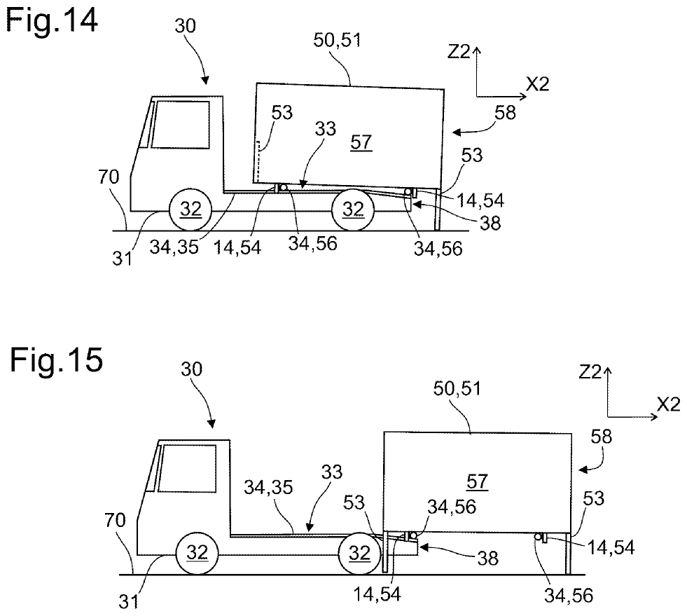

FIGS. 14 and 15 show the unloading of a container 50 from the LEFV 30, which takes place similarly in principle to the process of unloading from the truck 10. The rear legs 53 are adjusted into the deployed position. The container 50 is then moved with the rear second roller elements 54 down the ramp unit 38 such that the rear legs 53 make contact with the ground 70. The LEFV 30 is then driven forward until the front legs 53 are finally arranged behind the rear wheels 32 with respect to the longitudinal direction X2 and can likewise be adjusted into the deployed position. As can be seen from FIG. 11, the spacing of the legs 53 in the transverse direction Y2 is greater than the width of the ramp unit 38, such that said legs can be deployed to the sides of said ramp unit without problems. The front legs 53 thereafter finally make contact with the ground 70, such that the container 50 has been fully set down. The loading of the container is performed in the reverse sequence, and corresponds substantially to the procedure for loading onto the truck 10.

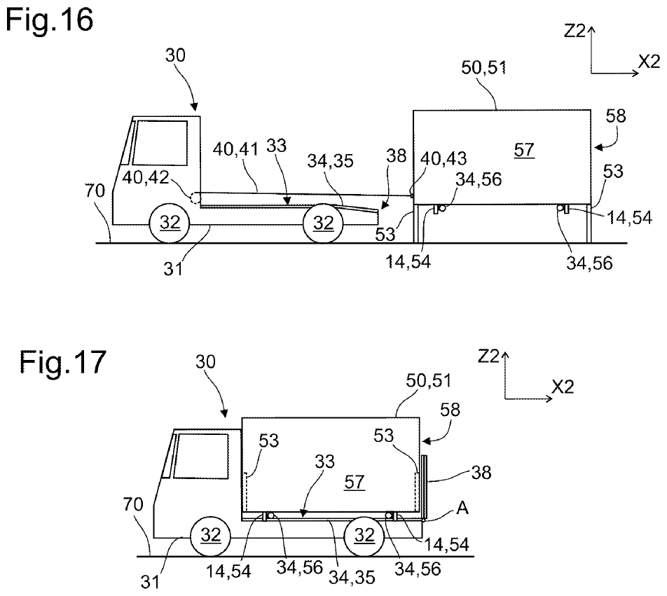

FIG. 16 shows a second embodiment of an LEFV 30, which differs from the first embodiment in that a traction device 40 is provided, having a traction cable 41 which can be wound up by means of a winch 42 and which, at the end, has a coupling element 43 that is schematically illustrated here. This may for example be designed as a hook that is hooked onto an eyelet of the container 50. By means of the traction device 40, which can be supplied with energy by means of batteries of the LEFV 30, the container 50 can be pulled onto the LEFV 30 and pulled into its intended end position on the cargo bed 33. For as long as the container 50 is still in contact with the ground, it is also possible here for the LEFV to move, at least proportionately relative to the ground 70, toward the container 50. It is also conceivable for the truck 10 to be equipped with a corresponding traction device 40.

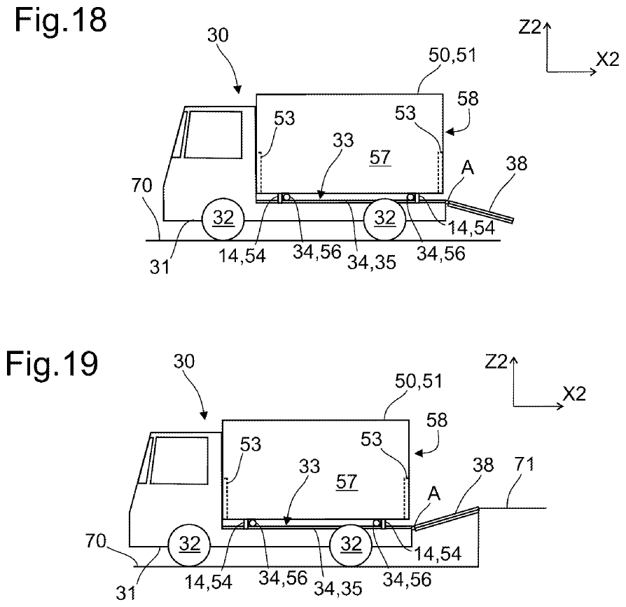

FIGS. 17 to 19 show a third embodiment of an LEFV 30, which differs from the first embodiment in that the ramp unit 38 is in this case not arranged fixedly on the vehicle body 31. Instead, said ramp unit is pivotable about a first pivot axis A that extends parallel to the transverse direction Y2. When a container 50 has been loaded as shown in FIG. 17, the ramp unit 38 may be set into an approximately vertical position so as to form a rear-side securing means for the container 50. For the loading and unloading of the container 50, the ramp unit 38 is tilted downwardly as illustrated in FIG. 18. The variable tilt may also be used for the purposes of transferring the container 50 without using the legs 53, for example onto an elevated platform 71, as illustrated in FIG. 19. For this purpose, the ramp unit 38 may be tilted upwardly and brought into contact with the platform 71. The container 50 can then be transferred, by being rolled on the second roller elements 56, onto the platform 71.

It is also possible for the truck 10 to be equipped with a pivotable ramp unit 38. In this way, it is also possible for the truck 10 to take on containers 50 directly from a platform 71, even if there is a height difference between the cargo bed 13 and platform 71.

### LIST OF REFERENCE SYMBOLS

1 Logistics system
10 Truck
11, 31 Vehicle body
12, 32 Wheel
13, 33 Cargo bed
14, 34 Movement arrangement
15, 35 Rail
18, 38 Ramp unit
20 Conveyor device
21 Conveyor belt
22 Driver element
23 Guide roller
30 LEFV
36 Flange portion
37 Run-in portion
40 Traction device
41 Traction cable
42 Winch
43 Coupling element
50 Container
51 Container body
52 Recess
53 Leg
54, 56 Roller elements
57 Long side
58 Short side
59 Long-side door
60 Short-side door
61 Long-side opening
62 Short-side opening
63 Container floor
65 Trolley
70 Ground
71 Platform
A, B Pivot axis
X1, X2 Longitudinal direction
Y1, Y2 Transverse direction
Z1, Z2 Vertical direction

What is claimed is:

1. Logistics system for use with a large vehicle and a small vehicle, comprising:
the container configured to be received, with a long side oriented along a transverse direction of the large vehicle, on the large vehicle, and wherein the container includes,
a first movement arrangement for interacting with the large vehicle, and configured so the container can be moved along a longitudinal direction of the large vehicle;
the container further configured to be received, with the long side oriented along a longitudinal direction of the small vehicle, on the small vehicle, and wherein the container further includes,
a second movement arrangement for interacting with the small vehicle, and configured so the container can be moved along the longitudinal direction of the small vehicle; and
multiple legs that are adjustable from a deployed position into a retracted position, in order for the container to be received on one of the large vehicle or small vehicle.

2. The logistics system of claim 1, wherein the first movement arrangement has at least one container-mounted runner element configured to interact with at least one vehicle-mounted track element.

3. The logistics system of claim 1, wherein the first movement arrangement has first roller elements, which are arranged on the container and oriented transversely to the long side of same, as runner elements, and which are configured to interact with first rails arranged on the large vehicle and extend along the longitudinal direction of the large vehicle as track elements.

4. The logistics system of claim 3, wherein the second movement arrangement has second roller elements, which are arranged on the container and oriented parallel to the long side of the container as runner elements, and configured to interact with second rails arranged on the small vehicle extending along the longitudinal direction of the small vehicle as track elements, wherein the first roller elements and the second roller elements project downward from the container to different extents.

5. The logistics system of claim 3, wherein the large vehicle includes a ramp unit that is arranged at a rear end of the large vehicle, and which is at least downwardly tiltable and which is configured to support at least one runner element whilst at least one leg is in contact with ground.

6. The logistics system of claim 1, further comprising a second containers configured to be received on the large vehicle such that long sides of each of the container and second container are arranged adjacent to one another, and consignments can be transferred between the containers via long-side openings formed in the long sides.

7. The logistics system of claim 1, wherein the large vehicle includes a ramp unit, and the ramp unit is configured, in order to receive the container, to be arranged between two legs of the container in a transverse direction.

8. The logistics system of claim 7, wherein the ramp unit is pivotable about a pivot axis extending in a transverse direction.

9. The logistics system of claim 1, wherein the container is configured to be coupled to a traction device (40) of the large vehicle, wherein the traction device is configured to pull the large vehicle and the container toward one another along the longitudinal direction.

10. The logistics system of claim 1, wherein the large vehicle includes a conveyor device that is configured to form-fittingly engage with the container and push the container, which is received on the large vehicle, along the longitudinal direction.

11. A logistics system including a first vehicle and a container, comprising:
the container configured to be received on the first vehicle, with a long side oriented along a transverse direction of the first vehicle, and wherein the container includes,
a first movement arrangement for interacting with the first vehicle, and configured so the container can be moved along a longitudinal direction of the first vehicle;
a second movement arrangement for interacting with the second vehicle, and configured so the container can be moved along the longitudinal direction of the second vehicle, and
multiple legs that are adjustable from a deployed position into a retracted position, in order for the container to be received on the first vehicle.

12. The logistics system of claim 11, wherein the first vehicle includes a ramp unit, and the ramp unit is configured, in order to receive the container, to be arranged between two legs of the container in a transverse direction.

13. The logistics system of claim 11, wherein the first movement arrangement has at least one container-mounted runner element configured to interact with at least one vehicle-mounted track element of the first vehicle.

14. The logistics system of claim 11, wherein the first movement arrangement has first roller elements, which are arranged on the container and oriented transversely to the long side of same, as runner elements, and which are configured to interact with first rails arranged on the first vehicle and extend along the longitudinal direction of the first vehicle as track elements.

15. The logistics system of claim 11, wherein the second movement arrangement has second roller elements, which are arranged on the container and oriented parallel to the long side of the container as runner elements, and configured to interact with second rails arranged on the first vehicle extending along the longitudinal direction of the first vehicle as track elements.
